(19) United States
(12) Patent Application Publication
(10) Pub. No.: US 2024/0189977 A1
(43) Pub. Date: Jun. 13, 2024

(54) Handheld Gripper

(71) Applicant: Noah Hungness, Houston, TX (US)

(72) Inventor: Noah Hungness, Houston, TX (US)

(21) Appl. No.: 18/076,990

(22) Filed: Dec. 7, 2022

(51) Int. Cl. B25J 1/02; B25J 15/00

(52) U.S. Cl. CPC B25J 1/02; B25J 15/0033

(57) ABSTRACT

Provided herein is a handheld device by which to grip a bank card. The device has a front portion or card-holding portion that slides over and removably secures the bank card via a plurality of grippers disposed within. The device has a back portion or handgrip portion where an opening through the handgrip accommodates the fingertips and fingernails of a user for ease in sliding the front portion over the bank card.

### BACKGROUND OF THE INVENTION

### Field of the Invention

The present invention relates generally to the field of handheld accessories. More specifically, the present invention is directed to a handheld gripper designed for easier handling of bank card.

### Description of the Related Art

Today's commerce relies heavily on bank cards for purchases. Paying for a purchase can require the constant retrieval of the bank card from a wallet or other card holder and insertion into and extraction from card readers at stores or ATMs should the consumer wish to pay in cash. However, some consumers have difficulty in performing these tasks. For example, the card user may have long fingernails, either natural or press on, and/or the nails may be decorated with nail art. Having to handle a credit card, debit card or other card with long fingernails is awkward and risks chipping the nail or otherwise damaging nail art applied thereon particularly when trying to retrieve the card from a card reader. Moreover, a consumer whose fingers are not easily workable due to injury, age or other condition can experience difficulty in handling these cards.

Currently, credit card grabbers rely on a spring clip to pull a card. Although designed with a handle to accommodate long nails, using the grabber still requires that the jaw on the clip is opened by the user pressing down on the upper jaw arm and held open until the card is between the open jaws. This still requires using a finger to open the jaws and a degree of exertion to keep the jaws open until the bank card is received within the grabber.

Thus, there is a recognized need for a gripper that receives and securely holds a bank card without the necessity of a user having to handle the card or physically manipulate a clip prior to its receiving the bank card within the jaws of a clip. Specifically, the prior art is deficient in a handheld gripper that slides over and retains the card without a user physically opening the gripper to receive the card and without handling the card. The present invention fulfills this longstanding need and desire in the art.

### SUMMARY OF THE INVENTION

The present invention is directed to a device for gripping a bank card that has a substantially U-shaped front portion with an open front end and a curved back end. A first plurality of grippers is formed in apposition on an inner surface of an upper arm of the U-shaped front portion where each of the first plurality of grippers extends downwardly therefrom. A second plurality of grippers is formed in apposition on an inner surface of a lower arm of the U-shaped front portion where each of the second plurality of grippers extends upwardly therefrom. A back portion with an upper surface, a lower surface and a back surface is formed on a back end of the lower arm of the U-shaped front portion to extend outwardly in horizontal alignment therefrom.

The present invention is directed to a related device that further comprises an opening formed through the upper surface and the lower surface of the back portion.

The present invention also is directed to a gripping device for a bank card. The gripping device has a card-holding portion with a substantially U-shaped body with an open card-receiving end and a closed arcuate back end. An upper arm with a first pair of grippers depends downwardly from an inner surface thereof and a lower arm with a second pair of grippers extends upwardly from an inner surface thereof. The upper arm and the lower arm extend in parallel from the closed arcuate back end and each having a front end surface that defines the open card-receiving end of the card-holding portion. A handgrip portion with an upper surface, a lower surface and a back surface is formed from the lower arm and is in alignment therewith along a horizontal plane and with an opening formed through the upper surface and the lower surface, where the opening is shaped to receive fingertips of a user.

The present invention is directed further to a handheld gripper for a credit card. The handheld gripper has a card gripping portion with an upper arm with an upper front end, a lower arm with a lower front end and a curved back end connecting the upper arm and the lower arm in a parallel relationship whereby the upper front end and the lower front end form an opening therein. The upper arm has a first pair of cuboidal grippers depending from its inner surface and a lower arm having a second pair of cuboidal grippers extending upwardly from its inner surface in vertical alignment with the first pair of cuboidal grippers with a vertical distance therebetween sized to removably receive and grip the card. A handheld portion has a flat upper surface, that is disposed in parallel with a flat lower surface, and a back surface and is formed from a lower back end of the lower arm to extend rearwardly along a horizontal plane therefrom. The handheld portion has an opening disposed through the flat upper surface and the flat lower surface is shaped to receive fingertips of a user therein.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 shows the gripping device or handheld device with the grippers on the card-receiving portion and the handheld portion or handgrip portion.

FIG. 2 is a cross-section of the card-receiving portion showing the receptacles in the upper and lower arms into which the grippers are inserted

FIG. 3 is a front view of the gripping device of FIG. 1 showing the open front end or open card-receiving end.

FIG. 4 is a back view of the gripping device of FIG. 1 showing the curved back end of the card-receiving portion.

FIG. 5 is top view of the gripping device of FIG. 1 showing the crescent shaped opening through the handheld portion.

### DETAILED DESCRIPTION OF THE PRESENT INVENTION

The articles “a” and “an” when used in conjunction with the term “comprising” in the claims and/or the specification, may refer to “one”, but is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure. Thus, a device for gripping a bank card with a length of about 4 inches includes a length of 3.6 inches to 4.4 inches.

As used herein, the term “U-shaped” refers to a shape substantially like the capital letter U rotated 90 degrees to lie on an arm thereof.

As used herein, the terms “device”, “device for gripping”, “gripping device”, and “handheld gripper” are interchangeable and the terms “open front end”, “open card-receiving end” and “card-receiving opening” are interchangeable.

As used herein, the terms “front” and “back” refer to portions and components of the gripping device that are respectively proximal to and distal to the open card-receiving end.

In one embodiment of the present invention, there is provided a device for gripping a bank card, comprising a substantially U-shaped front portion with an open front end and a curved back end; a first plurality of grippers formed in apposition on an inner surface of an upper arm of the U-shaped front portion, each of said first plurality of grippers extending downwardly therefrom; a second plurality of grippers formed in apposition on an inner surface of a lower arm of the U-shaped front portion, each of said second plurality of grippers extending upwardly therefrom; a back portion with an upper surface, a lower surface and a back surface formed on a back end of the lower arm of the U-shaped front portion to extend outwardly in horizontal alignment therefrom.

Further to this embodiment the gripping device comprises an opening formed through the upper surface and the lower surface of the back portion. In this further embodiment the opening may have a crescent shape bounded a beveled inner surface.

In both embodiments the upper arm may comprise a beveled upper front surface and the lower arm may comprise a beveled lower front surface. Also in both embodiments the back surface of the back portion may be beveled. In addition the bank card may be a credit card, a debit card or an ATM debit card.

In both embodiments each of the first plurality of grippers and each of the second plurality of grippers are cuboidal in shape. Particularly, each of the first plurality of grippers has dimensions identical to each of the second plurality of grippers. Also, the first plurality of grippers are in vertical alignment with the second plurality of grippers. In addition the first plurality of grippers and the second plurality of grippers may be in vertical alignment such that a space is formed with a vertical distance therebetween that is sized to removably receive and secure the bank card.

In another embodiment of the present invention, there is provided a gripping device for a bank card, comprising a card-holding portion with a substantially U-shaped body having an open card-receiving end and a closed arcuate back end and comprising an upper arm with a first pair of grippers depending downwardly from an inner surface thereof and a lower arm with a second pair of grippers extending upwardly from an inner surface thereof, the upper arm and the lower arm extending in parallel from the closed arcuate back end and each having a front end surface that defines the open card-receiving end of the card-holding portion; and a handgrip portion with an upper surface, a lower surface and a back surface that is formed from the lower arm and in alignment therewith along a horizontal plane and with an opening formed through the upper surface and the lower surface, the opening shaped to receive fingertips of a user. In this embodiment the bank card may be as described supra.

In this embodiment the front end surface of the upper arm, the front end surface of the lower arm, the arcuate back end, and the back surface of the handgrip portion may be beveled. Also in this embodiment the opening through the handgrip portion may have a crescent shape and bounded by a beveled inner surface. In addition the first pair of grippers is in vertical alignment with the second pair of grippers and form a space therebetween that is sized to removably receive and secure the card within the card-holding portion. Furthermore the first pair of grippers may have dimensions identical to the second pair of grippers.

In yet another embodiment of the present invention, there is provided a handheld gripper for a credit card, comprising a card gripping portion comprising an upper arm with an upper front end, a lower arm with a lower front end and a curved back end connecting the upper arm and the lower arm in a parallel relationship whereby the upper front end and the lower front end form a card-receiving opening therein, the upper arm having a first pair of cuboidal grippers depending from its inner surface and said lower arm having a second pair of cuboidal grippers extending upwardly from its inner surface in vertical alignment with the first pair of cuboidal grippers with a vertical distance therebetween sized to removably receive and grip the card; and a handheld portion comprising a flat upper surface disposed in parallel with a flat lower surface and a back surface and formed from a lower back end of the lower arm to extend rearwardly along a horizontal plane therefrom, the handheld portion having an opening disposed through the flat upper surface and the flat lower surface shaped to receive fingertips of a user therein.

In this embodiment the first pair of cuboidal grippers may have dimensions identical to the second pair of cuboidal grippers. Also the opening through the handheld portion may be crescent shaped and bounded by a beveled surface. In addition the upper front end of the upper arm, the lower front end of the lower arm, the curved back end, and the back surface of the handheld portion may be beveled.

Provided herein are handheld devices for receiving and gripping a bank card therein, for example, but not limited to, a credit card, a debit card or an ATM debit card. The handheld or gripping devices have two portions or components or sections that are formed as a unit. A front portion is the card-receiving portion and a back portion is the handgrip portion designed to accommodate a user's fingertips, including fingernails, for example, long fingernails whether natural or press on. A crescent shaped opening through the handgrip portion enables a user with long fingernails and/or nail art thereon to hold the gripping device securely while protecting the nails and/or enables a user who has difficulty flexing and bending the fingers or difficulty in grasping a thin card with enough strength to pull it from a wallet or device.

The handheld or gripping devices may be a combination of a plastic material or other synthetic polymer, for example, but not limited to, an acrylic material, and a rubber material as are known and standard in the art. Particularly, the grippers comprise the rubber material and the other portions, parts or components of the device comprise the plastic material. The device may be black or white in color or any combination of colors. The device may have overall dimensions of about 4 in. in length, about 2-2.5 in. in width and about 1 in. in depth. Preferably, the dimensions of the device may be divided into the length (from front end to back end), height (from lower surface to upper surface) and depth (across the upper surfaces) of the upper arm, the lower arm, the curved back end and the grippers of the front portion and the handgrip portion as shown in Table 1. The dimensions of each gripper are identical.

TABLE 1
Dimensions of device components

| | Length | Height | Depth |
|---|---|---|---|
| Component | (inches) | (inches) | (inches) |
| Upper arm | 2.06 | 1-1.25 | 0.2-0.3 |
| Lower arm | 2.09 | 2-2.5 | 0.25-0.3 |
| Curved back end | 0.57 | 2-2.5 | 0.75 |
| Grippers | | | 0.30 |
| Handheld grip | 1.91 | 2-2.5 | 0.25-0.3 |
| Opening in grip | 0.35-0.4 | 2-2.5 | 0.25-0.3 |

The handheld device is designed with a vertical space between the upper and lower rubber grippers sized to accommodate the thickness of the bank card. The known flexibility and elasticity of the rubber enables the card to slide into the card receiving portion between the upper and lower rubber grippers when a user pushes the open end of the device over the card and secures the card therein. This enables a user to more easily pull the bank card out of a wallet or other card holder or out of a card reader, an ATM or other device into which the bank card has been manually inserted.

Particular embodiments of the present invention are better illustrated with reference to the Figure(s), however, such reference is not meant to limit the present invention in any fashion. The embodiments and variations described in detail herein are to be interpreted by the appended claims and equivalents thereof.

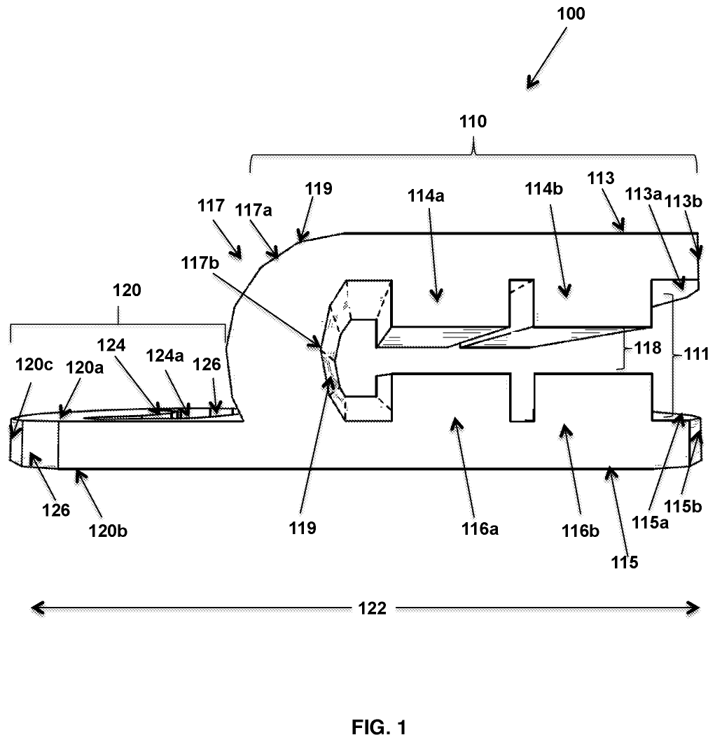

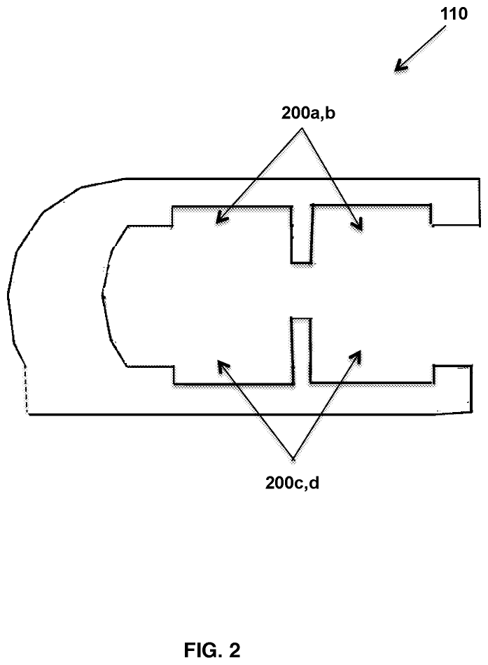

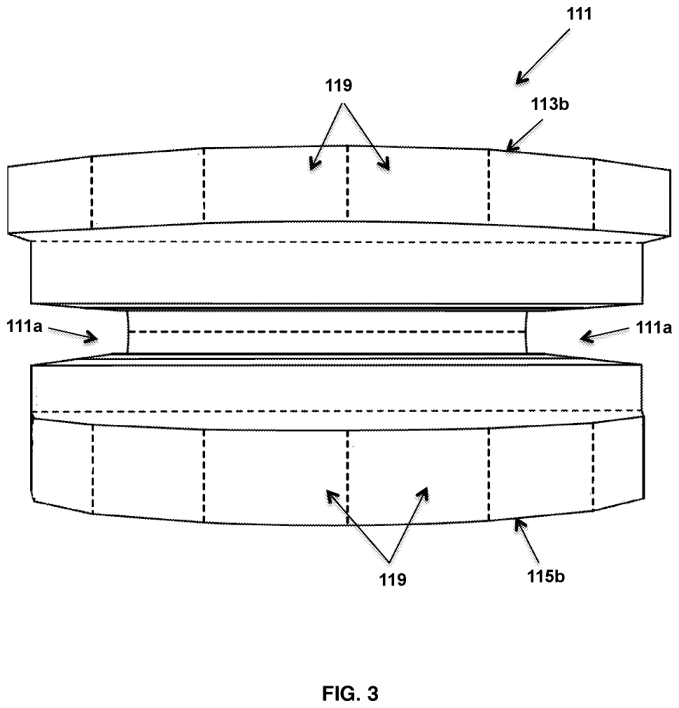

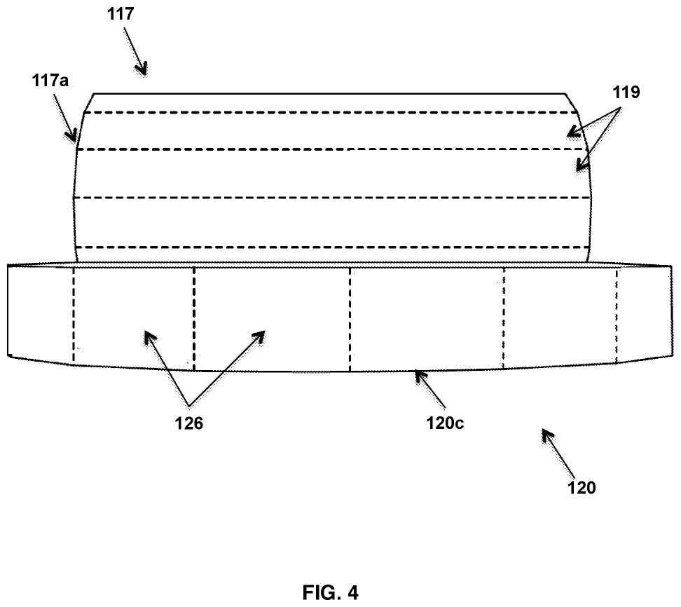

FIG. 1 shows the device for gripping a card. The device 100 has a front portion 110 and a back portion 120. The front portion comprises the card-receiving end 111 and is substantially U-shaped with upper 113 and lower 115 arms extending in parallel from a curved or arcuate back end 117. A plurality, such as represented by a pair of grippers 114a,b, are secured (see FIG. 2) to the lower surface 113a of the upper arm to depend therefrom. A plurality of grippers, equal in number to that depending from the upper arm, such as represented by grippers 116a,b are secured to the upper surface 115a of the lower arm to extend upwardly therefrom. The grippers on the upper arm are in alignment with the grippers on the lower arm and with a vertical spacing or distance 118 therebetween to removably receive and secure a card therein. The upper front surface 113b of the upper arm and the lower front surface 115b of the lower arm are beveled and the back surface 117a and front surface 117b of the curved back end are beveled as represented by 119 (see FIGS. 3-4) on each surface.

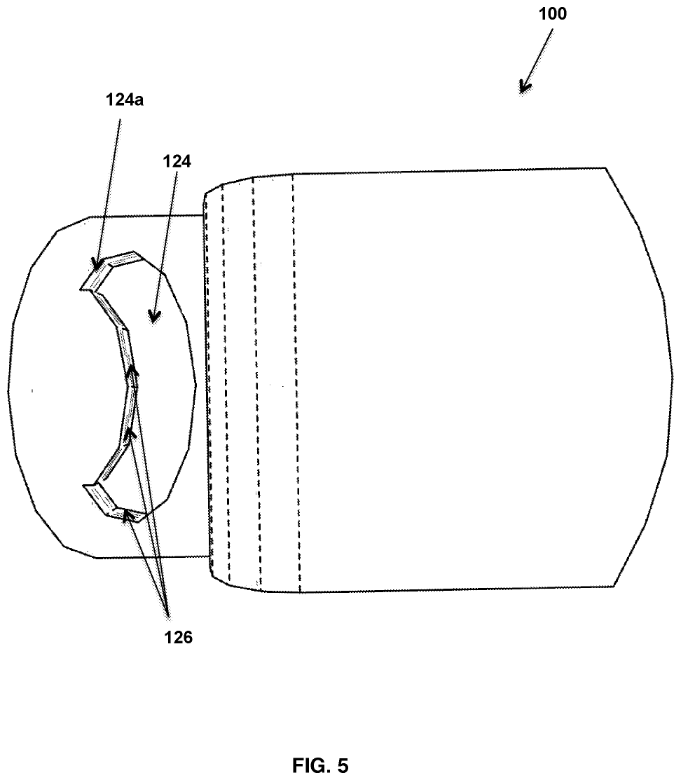

The back portion is formed from the back of the lower arm to extend outwardly along the horizontal plane, represented by 122, containing the lower arm. The back portion has an upper surface 120a, a lower surface 120b and a back surface 120c. A crescent shaped opening 124 is formed through the upper surface and the lower surface. The back surface of the back portion (see FIG. 4) and the inner circumferential surface 124a of the crescent shaped opening are beveled (see FIG. 5) are beveled, as represented by 126.

With continued reference to FIG. 1, FIG. 2 is a cross-section of the front portion 110 of the device showing the receptacles 200a,b,c,d into which the grippers and are inserted and secured.

With continued reference to FIG. 1, FIG. 3 shows the opening 111a at the card-receiving end 111 of the device into which the card is inserted between the upper arm and the lower arm. The upper front surface 113b of the upper arm and the lower front surface 115b are beveled, as represented by 119.

With continued reference to FIG. 1, FIG. 4 shows the beveling, as represented by 119, on the back surface 117a of the curved back end 117 and the beveling, as represented by 124, on the back surface 120c of the back portion 120.

With continued reference to FIG. 1, FIG. 5 is a top view of the device 100 showing beveling 126 of the inner surface 124a bounding the crescent shaped opening 124.

What is claimed is:

1. A device for gripping a bank card, comprising:
a substantially U-shaped front portion with an open front end and a curved back end;
a first plurality of grippers formed in apposition on an inner surface of an upper arm of the U-shaped front portion, each of said first plurality of grippers extending downwardly therefrom;
a second plurality of grippers formed in apposition on an inner surface of a lower arm of the U-shaped front portion, each of said second plurality of grippers extending upwardly therefrom;
a back portion with an upper surface, a lower surface and a back surface formed on a back end of the lower arm of the U-shaped front portion to extend outwardly in horizontal alignment therefrom.

2. The device of claim 1, further comprising an opening formed through the upper surface and the lower surface of the back portion.

3. The device of claim 2, wherein the opening has a crescent shape bounded by a beveled inner surface.

4. The device of claim 1, wherein the upper arm comprises a beveled upper front surface, the lower arm comprises a beveled lower front surface or the curved back end comprises a beveled outer surface and a beveled inner surface or a combination thereof.

5. The device of claim 1, wherein the back surface of the back portion is beveled.

6. The device of claim 1, wherein each of the first plurality of grippers and each of the second plurality of grippers are cuboidal in shape.

7. The device of claim 6, wherein each of the first plurality of grippers has dimensions identical to each of the second plurality of grippers.

8. The device of claim 1, wherein the first plurality of grippers are in vertical alignment with the second plurality of grippers.

9. The device of claim 8, wherein the first plurality of grippers and the second plurality of grippers are in vertical alignment such that a space is formed with a vertical distance therebetween that is sized to removably receive and secure the bank card.

10. The device of claim 1, wherein the bank card is a credit card, a debit card or an ATM debit card.

11. A gripping device for a bank card, comprising:
a card-holding portion with a substantially U-shaped body having an open card-receiving end and a closed arcuate back end and comprising:
an upper arm with a first pair of grippers depending downwardly from an inner surface thereof and a lower arm with a second pair of grippers extending upwardly from an inner surface thereof, said upper arm and said lower arm extending in parallel from the closed arcuate back end and each having a front end surface that defines the open card-receiving end of the card-holding portion; and
a handgrip portion with an upper surface, a lower surface and a back surface that is formed from the lower arm and in alignment therewith along a horizontal plane and with an opening formed through the upper surface and the lower surface, said opening shaped to receive fingertips of a user.

12. The gripping device of claim 11, wherein the front end surface of the upper arm, the front end surface of the lower arm, the arcuate back end, and the back surface of the handgrip portion are beveled.

13. The gripping device of claim 11, wherein the opening through the handgrip portion has a crescent shape and bounded by a beveled inner surface.

14. The gripping device of claim 11, wherein the first pair of grippers is in vertical alignment with the second pair of grippers and form a space therebetween that is sized to removably receive and secure the card within the card-holding portion.

15. The gripping device of claim 11, wherein the first pair of grippers has dimensions identical to the second pair of grippers.

16. The gripping device of claim 11, wherein the bank card is a credit card, a debit card or an ATM debit card.

17. A handheld gripper for a credit card, comprising:
a card gripping portion comprising an upper arm with an upper front end, a lower arm with a lower front end and a curved back end connecting the upper arm and the lower arm in a parallel relationship whereby the upper front end and the lower front end form a card-receiving opening therein, said upper arm having a first pair of cuboidal grippers depending from its inner surface and said lower arm having a second pair of cuboidal grippers extending upwardly from its inner surface in vertical alignment with the first pair of cuboidal grippers with a vertical distance therebetween sized to removably receive and grip the card; and
a handheld portion comprising a flat upper surface disposed in parallel with a flat lower surface and a back surface and formed from a lower back end of the lower arm to extend rearwardly along a horizontal plane therefrom, said handheld portion having an opening disposed through the flat upper surface and the flat lower surface shaped to receive fingertips of a user therein.

18. The handheld gripper of claim 17, wherein the first pair of cuboidal grippers has dimensions identical to the second pair of cuboidal grippers.

19. The handheld gripper of claim 17, wherein the opening through the handheld portion is crescent shaped and bounded by a beveled surface.

20. The handheld gripper of claim 17, wherein the upper front end of the upper arm, the lower front end of the lower arm, the curved back end, and the back surface of the handheld portion are beveled.
